(19) United States
(12) Patent Application Publication
(10) Pub. No.: US 2007/0273889 A1
(43) Pub. Date: Nov. 29, 2007

(54) Calibration method for optical modulator

(75) Inventors: Seung-Do An, Suwon-si (KR); Seung-Won Ryu, Suwon-si (KR); Anatoliy Lapchuk, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO. LTD., Suwon (KR)

(21) Appl. No.: 11/798,772

(22) Filed: May 16, 2007

(30) Foreign Application Priority Data
May 17, 2006 (KR) 10-2006-0044234

(51) Int. Cl. G01C 19/72

(52) U.S. Cl. 356/460

(57) ABSTRACT

An aspect of the present invention features a calibration apparatus for an optical modulator comprising: a light source emitting a beam to the optical modulator; an optical scanning unit scanning and projecting a beam emitted from the optical modulator; a light measuring unit measuring a beam emitted from the light source; and a light source control unit controlling the light source to the optical scanning unit to emit a calibration beam that is invisible and can be sensed by the light measuring unit. The calibration apparatus for an optical modulator according to the present invention can be electrically controlled to have various applications

### CROSS-REFERENCE TO RELATED APPLICATIONS

This application claims the benefit of Korean Patent Application No. 10-2006-0044234 filed with the Korean Intellectual Property Office on May. 17, 2006, the disclosures of which are incorporated herein by reference in their entirety.

### BACKGROUND

1. Technical Field

The present invention relates to a display apparatus and a display method thereof, in particular to a calibration apparatus for an optical modulator.

2. Description of the Related Art

Unlike the existing information processing technology, an optical signal processing is advantageous in that it can process information fast and parallel, and also can process a large volume of data in real time, and such an advantage has encouraged a lot of developments on a design of a binary phase filter, an optical logic gate, an optical amplifier, an optical element, and an optical modulator, all of which are related to spatial optical modulation theory.

Here, the optical modulator refers to a device that allows to manipulate a property of an optical beam, loading signals on the optical beam.

The optical modulator is used in such fields as optical memory, optical display, printers, optical interconnection, and holograms, etc., and a great deal of development research is currently under way on display devices using the optical modulator.

Such an optical modulator relates to MEMS (Micro Electro Mechanical System), which uses semiconductor manufacturing technology to form three-dimensional structures on silicon substrates. There are a variety of applications in which the MEMS is used, examples of which include various sensors for vehicles, inkjet printer heads, HDD magnetic heads, and portable telecommunication devices, in which the trend is towards smaller devices capable of more functionalities.

The MEMS element has a bendable part spaced from the substrate to perform minute mechanical movement.

The MEMS can also be called a micro electromechanical system or element, and one of its applications is in the optical science field. Using micromachining technology, optical components smaller than 1 mm can be fabricated, by which micro optical systems can be implemented. Specially fabricated semiconductor lasers may be attached to supports prefabricated by micromachining technology, so that micro Fresnel lenses, beam splitters, and 45° reflective mirrors may be manufactured and assembled by micromachining technology. The existing optical systems are composed using assembly tools to place mirrors and lenses, etc. on large, heavy optical benches. The size of the lasers is also large.

To obtain performance in optical systems such composed, significant effort is required in the several stages of careful adjustment to calibrate the light axes, reflective angles, and reflective surfaces, etc.

Micro optical systems are currently selected and applied in telecommunication devices and information display and recording devices, due to such advantages as quick response time, low level of loss, and convenience in layering and digitalizing. For example, micro optical components such as micro mirrors, micro lenses, and optical fiber supports may be applied to data storage recording devices, large image display devices, optical communication elements, and adaptive optics.

Here, micromirrors are applied in various ways according to the direction, such as the vertical, rotational, and sliding direction, and to the static and dynamic movement. Movement in the vertical direction is used in such applications as phase compensators and diffractors, with movement in the direction of inclination used in applications such as scanners or switches, optical splitters, optical attenuators, and movement in the sliding direction used in optical shields or switches, and optical splitters. The size and number of micromirrors vary considerably according to the application, and the application varies according to the direction of movement and to whether the movement is static or dynamic. Of course, the method of manufacturing micromirrors also varies accordingly.

Recently, as projection televisions, mobile projectors and the like have been introduced in the market, an optical beam scanner is being used as a beam projector.

FIG. 1a is a schematic view of a conventional display apparatus using an optical modulator and a polygon mirror. In FIG. 1a are illustrated a light source 110, a control part 120, a lens 130, an optical modulator 135, a polygon mirror 140, and a screen 150.

Here, although an optical modulator is dispensable in a mobile projector, descriptions below will concentrate on a mobile projector using an optical modulator.

The light source 110 generates a laser beam, which is later reflected and diffracted by the optical modulator 135. Here, the light source 110 emits laser beams simultaneously in a vertical direction, and the polygon mirror 140 rotates to reflect the laser beams, creating a two-dimensional image. The light source 110 may be composed of a laser or a laser diode, and the control part 120 controls the light source 110 to turn on/off, whereupon a laser beam is generated.

The lens 130 collects the laser beams emitted from the light source 110 toward a rotational axis of the polygon mirror 140. The control part 120 controls the polygon mirror 140 to be turned on/off, and the polygon mirror 140 rotates at a constant angular speed. Since the polygon mirror 140 has a polygonal shape, each facet of which reflects incident beams while rotating. The polygon mirror 140 has a bidirectionally rotatable motor (not shown in the accompanying drawings), and rotates thanks to the motor, thereby reflecting to the screen 150 the incident beams projected through the lens 130

Here, in order to secure image uniformity, it is necessary that each pixel of the optical modulator be calibrated before released to the market. Generally, the optical modulator is calibrated through supplying an initial voltage by which the optical modulator is operated, finding out a compensation voltage by analyzing the light outputted from the optical modulator and applying the compensation voltage to the optical modulator.

Furthermore, as the image projector grows older, the image quality can deteriorate, so that it is necessary that the calibration be conducted after the image projector is in use.

However, for conducting a calibration, an additional device has been required to shut off the calibration beam, which is a visual ray, thereby complicating the structure and the operation of the projector.

### SUMMARY

The present invention provides a calibration apparatus for an optical modulator that has a simple structure.

Also, the present invention provides a calibration apparatus for an optical modulator that is electrically controlled to have various applications.

An aspect of the present invention features a calibration apparatus for an optical modulator comprising: a light source emitting a beam to the optical modulator; an optical scanning unit scanning and projecting a beam emitted from the optical modulator; a light measuring unit measuring a beam emitted from the light source; and a light source control unit controlling the light source to the optical scanning unit to emit a calibration beam that is invisible and can be sensed by the light measuring unit.

The light measuring unit can detect a beam emitted from the light source, and measures the quantity of light of the beam.

The calibration beam can be projected in accordance with an edge of a frame of an image outputted by the optical modulator.

The light measuring unit can be chosen from among a photodiode sensor, a CMOS image sensor, and a CCD image sensor.

Or, the calibration apparatus can comprise: a light source emitting a beam to the optical modulator; a semi-transmission filter partially transmitting a beam outputted from the optical modulator; an optical scanning unit scanning and projecting a beam transmitted by the semi-transmission filter in one direction; a light measuring unit measuring a beam transmitted by the semi-transmission filter in another direction; and a light source control unit controlling the light source to emit to the optical scanning unit a calibration beam that is invisible and can be sensed by the light measuring instrument.

The optical scanning unit can scan a beam transmitted by the semi-transmission filter, and the light measuring unit measures a beam reflected by the semi-transmission filter.

The optical scanning unit can scan a beam reflected by the semi-transmission filter, and the light measuring unit measures a beam transmitted by the semi-transmission filter.

The light measuring unit can measure the quantity of a beam emitted from the light source.

The light measuring unit can measure the frequency of a beam emitted from the light source.

The calibration beam can be projected in accordance with an edge of a frame of an image outputted by the optical modulator.

The light measuring unit can be chosen from among a photodiode sensor, a CMOS image sensor, and a CCD image sensor.

Or, the calibration apparatus can comprise: a light source emitting a beam to the optical modulator; an optical scanning unit scanning and projecting a beam outputted from the optical modulator; a light measuring unit measuring a beam reflected from the optical scanning unit in a predetermined direction; and a light source control unit controlling the light source to emit to the optical scanning unit a calibration beam that is invisible and can be sensed by the light measuring unit.

The light measuring unit can measure the quantity of a beam emitted from the light source.

The light measuring unit can measure the frequency of a beam emitted from the light source.

The calibration beam can be projected in accordance with an edge of a frame of an image outputted by the optical modulator.

The light measuring unit can be chosen from among a photodiode sensor, a CMOS image sensor, and a CCD image sensor.

Additional aspects and advantages of the present general inventive concept will be set forth in part in the description which follows, and in part will be obvious from the description, or may be learned by practice of the general inventive concept.

### BRIEF DESCRIPTION OF THE DRAWINGS

These and other features, aspects, and advantages of the present invention will become better understood with regard to the following description, appended claims, and accompanying drawings where:

FIG. 1 is a schematic view of a display apparatus using an optical modulator and a polygon mirror according to a prior art.

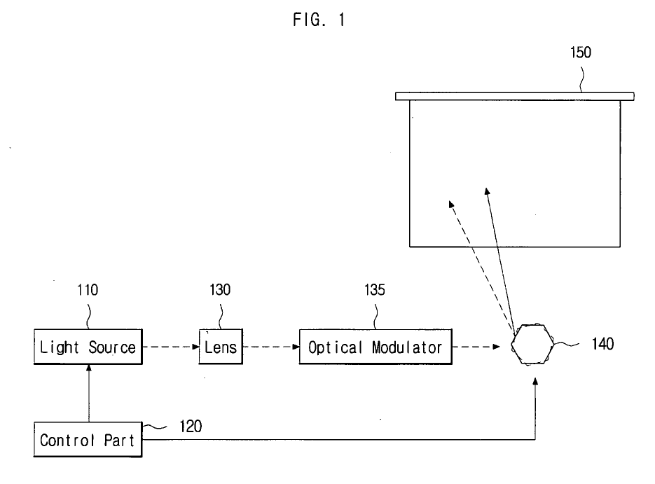

FIG. 2 is a perspective view of a diffraction type optical modulator module using piezoelectric elements applicable to an embodiment of the present invention.

FIG. 3 is a plan view of a diffraction type optical modulator array applicable to an embodiment of the present invention.

FIG. 4 is a schematic diagram illustrating an image generated on a screen by means of a diffraction type optical modulator array applicable to an embodiment of the invention.

FIG. 5 shows a correlation between the power of a laser beam and an image projected to a screen in an embodiment of the present invention.

FIG. 6 is a schematic view of a calibration apparatus for an optical modulator according to a first embodiment of the present invention.

FIG. 7 is a schematic view of a calibration apparatus for an optical modulator according to a second embodiment of the present invention.

### DETAILED DESCRIPTION

Hereinafter, embodiments of the invention will be described in more detail with reference to the accompanying drawings. In the description with reference to the accompanying drawings, those components are rendered the same reference number that are the same or are in correspondence regardless of the figure number, and redundant explanations are omitted.

An optical modulator applied to the present invention will first be described before discussing embodiments of the present invention.

The optical modulator is mainly divided into a direct type, which directly controls the on/off state of light, and an indirect type, which uses reflection and diffraction. The indirect type may be further divided into an electrostatic type and a piezoelectric type.

The optical modulators are applicable to the embodiments of the invention regardless of the operation type. An electrostatic type grating optical modulator as disclosed in U.S. Pat. No. 5,311,360 includes a plurality of equally spaced deformable reflective ribbons having reflective surfaces and suspended above an upper part of the substrate.

First, an insulation layer is deposited onto a silicon substrate, followed by depositions of a sacrificial silicon dioxide film and a silicon nitride film. The silicon nitride film is patterned with the ribbons, and some portions of the silicon dioxide film are etched so that the ribbons are maintained by a nitride frame on an oxide spacer layer. The ribbon and the oxide spacer of the optical modulator are designed to have a thickness of λ₀/4 in order to modulate a light having a single wavelength λ₀. The grating amplitude, of such a modulator limited to the vertical distance d between the reflective surfaces of the ribbons and the reflective surface of the substrate, is controlled by supplying a voltage between the ribbons (the reflective surface of the ribbon, which acts as a first electrode) and the substrate (the conductive film at the bottom portion of the substrate, which acts as a second electrode).

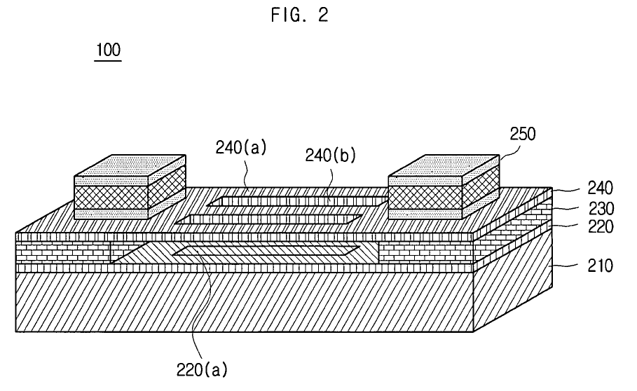

FIG. 2 is a perspective view of a micro-mirror included in a diffraction type optical modulator module using piezoelectric elements, applicable to the present invention.

In FIG. 2 illustrated an optical modulator 100, each comprising a substrate 210, an insulation layer 220, a sacrificial layer 230, a ribbon structure 240, and piezoelectric elements 250. The substrate 210 is a commonly used semiconductor substrate, and the insulation layer 220 is deposited as an etch stop layer. The insulation layer 220 is formed from a material with a high selectivity to the etchant (the etchant is an etchant gas or an etchant solution) that etches the material used as the sacrificial layer. Here, reflective layers 220(a) may be formed on the insulation layer 220 to reflect incident beams of light.

The sacrificial layer 230 supports the ribbon structure 240 so that the ribbon structure 240 is displaced by a particular gap from the insulation layer 220, and forms a space in the center part.

The ribbon structure 240 creates diffraction and interference in the incident light to provide optical modulation of signals as described above.

The form of the ribbon structure 240 may be composed of a plurality of ribbon shapes according to the electrostatic type, or may comprise a plurality of open holes in the center portion of the ribbons according to the piezoelectric type. The piezoelectric elements 250 control the ribbon structure 240 to move vertically, according to the degree of up/down or left/right contraction and expansion generated by the difference in voltage between the upper and lower electrodes. Here, the reflective layers 220(a), 220(b) are formed in correspondence with the holes 240(b), 240(d) formed in the ribbon structure 240. For example, in the case where the wavelength of a beam of light is λ, when there is no power supplied or when there is a predetermined amount of power supplied, the gap between the ribbon structure and the insulation layer 220, on which is formed a lower reflective layer 220(a), is equal to λ/2. Therefore, in the case of a 0th-order diffracted (reflected) beam of light, the overall path length difference between the light reflected by the ribbon structure and the light reflected by the insulation layer 220 is equal to λ, so that constructive interference occurs and the diffracted light is rendered its maximum luminosity. In the case of +1st or −1st order diffracted light, however, the luminosity of the light is at its minimum value due to a destructive interference. Also, when an appropriate amount of power is supplied to the piezoelectric elements 250, the gap between the ribbon structure and the insulation layer 220, on which is formed the lower reflective layer 220(a), becomes λ/4. Therefore, in the case of a 0th-order diffracted beam of light, the overall path length difference between the light reflected by the ribbon structure 240 and the light reflected by the insulation layer 220 is equal to λ/2, so that destructive interference occurs, and the diffracted light is rendered its minimum luminosity. In the case of +1st or −1st order diffracted light, however, the luminosity of the light is at its maximum value due to constructive interference. As a result of such interference, the optical modulator can load signals on the beams of light by controlling the quantity of the reflected or diffracted light.

Although the foregoing describes the cases in which the gap between the ribbon structure 240 and the insulation layer 220, on which is formed the lower reflective layer 220(a), is λ/2, it is obvious that a variety of embodiments, which operate with a gap controlling the intensity of interference by diffraction and reflection, can be applied to the present invention.

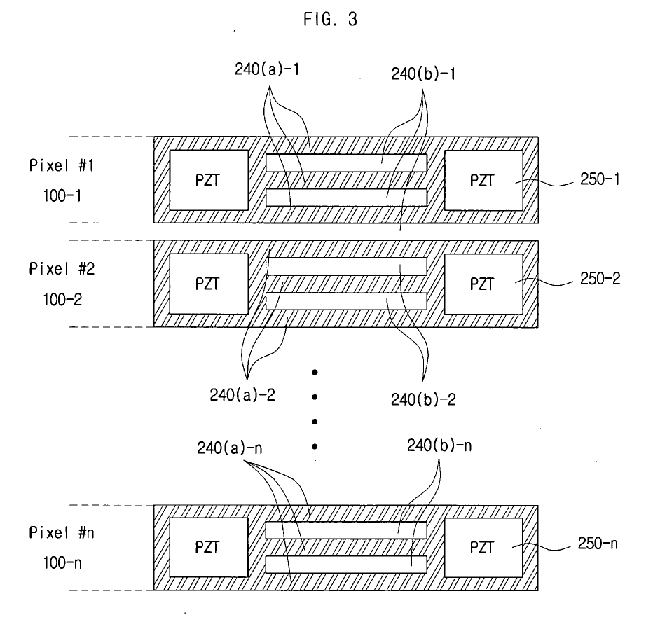

Referring to FIG. 3, the optical modulator is composed of an m number of micromirrors 100-1, 100-2, . . . , 100-m, each responsible for pixel #1, pixel #2, . . . , pixel #m. The optical modulator deals with image information on one-dimensional images of vertical or horizontal scanning lines (Here, it is assumed that a vertical or horizontal scanning line consists of an m number of pixels.), while each micromirror 100-1, 100-2, . . . , 100-m deals with one pixel among the m pixels constituting the vertical or horizontal scanning line. Thus, the light reflected and diffracted by each micromirror is later projected by an optical scanning device as a 2-dimensional image on a screen.

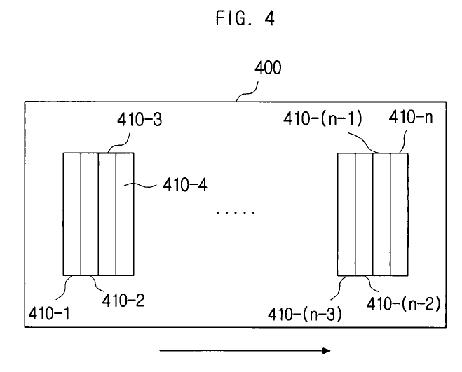

Referring to FIG. 4, a n number of vertically arranged micromirrors 100-1, 100-2, . . . , 100-n are scanned horizontally onto a screen 400 by the optical scanning device, whereby a picture 410-1, 410-2, 410-3, 410-4, . . . , 410-(n-3), 410-(n-2), 410-(n-1), 410-n is generated. Here, although the scanning is performed from left to right (the arrow indicating direction), it is apparent that images can be scanned in the opposite direction.

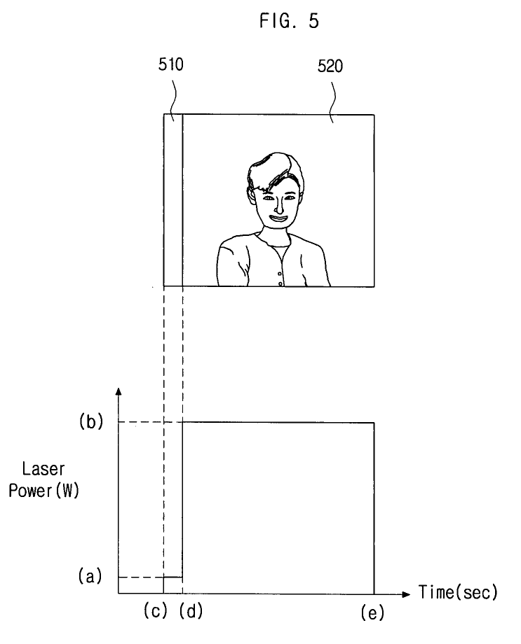

FIG. 5 illustrates a relation between the laser power of a calibration beam and an image projected to a screen in an embodiment of the present invention. In FIG. 5 are illustrated a screen 510 to which a calibration beam is emitted, a screen image 520 and a graph showing the power of a laser beam according to time.

The calibration beam refers to a light that is invisible to human eye but has a wavelength that can be sensed by a light measuring unit, and is used to calibrate the optical modulator. The visible light has a wavelength spectrum roughly from 380 nm to 770 nm. The color of the visible light varies depending on the wavelength, representing a color spectrum from red to violet, and the nearer to violet the color is, the shorter the wavelength becomes. In the case of a monochromatic light, human eyes perceive 750 nm to 610 nm as red, 610 nm to 590 nm as orange, 590 nm to 570 nm as yellow, 570 nm to 500 nm as green, 500 nm to 450 nm as blue, and 450 nm and 380 nm as violet.

Here, it should be noted that no additional unit is required to shut off the calibration beam since the calibration beam is an invisible light that a light measuring unit can detect to judge whether the calibration beam has a predetermined quantity of light.

In FIG. 5, (a) indicates a laser power of the calibration beam, and (b) indicates a laser power of a beam constructing an image. Here, the frequency of a beam determines the laser power, and the weaker the laser power, the lower the frequency of the beam. It takes as much time as from (c) to (e) to produce one frame, and the calibration beam is emitted at an edge of a frame. A light source emits the calibration beam during the time from (c) to (d), and the calibration beam has a different frequency from the beam constructing the image 520.

Here, the calibration beam can create a spot or a line as an image. The light source emits light for a shorter time when imaging a spot than when imaging a line. Also, while the line is imaged by the calibration beam, the luminance of the calibration beam can be altered, and in such a case, the luminance can be controlled by regulating voltage supplied to the optical modulator. For example, if the optical modulator emits light with the lowest luminance when 0V is applied to the optical modulator and light with the highest luminance when 10V is applied to the optical modulator, the optical modulator can be calibrated through increasing the voltage supplied to the optical modulator from 0V to 10V while the calibration beam is emitted to the optical modulator, measuring the luminance changing according to the voltage increase to compare with a reference, and adjusting the voltage applied in correspondence with the luminance when the measured luminance is different from the reference. The calibration beam is projected on an edge of a frame, so that the calibration beam does not affect the image quality. Although the above describes a case where the calibration beam is projected once per frame, it should be noted that the calibration beam can be projected more than one times.

Here, any light beam can be the calibration beam as long as it has a wavelength outside of the wavelength range of the visible light. Therefore, a calibration apparatus according to the present invention can have a simple structure, and the light measuring unit can be located in various positions so that the calibration apparatus suitable for a small display apparatus. Specifically, under the current trend that a mobile device becomes smaller, the calibration apparatus according to the present invention can be more widely used.

The above description concentrates on a general principle of a calibration. Hereinafter, a composing method of a calibration apparatus according to the present invention will be described with reference to the accompanying drawings. The composing method introduces two embodiments, which will be described one by one.

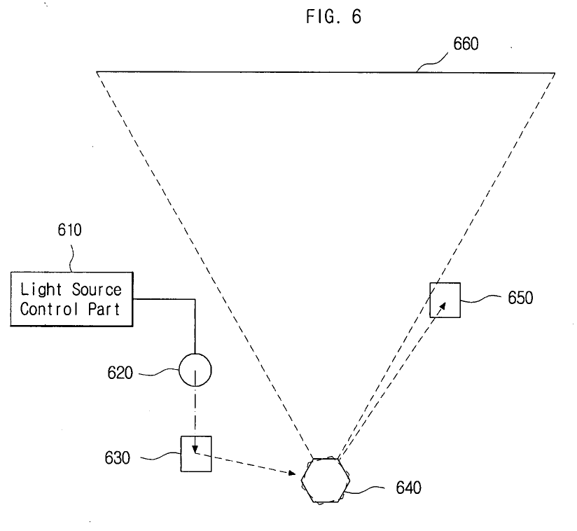

FIG. 6 is a schematic view of a calibration apparatus for an optical modulator according to a first embodiment of the present invention. Referring to FIG. 6, the apparatus includes a light source control unit 610, a light source 620, an optical modulator 630, an optical scanning unit 640, a light measuring unit 650, and a screen 660. Here, a lens, which expands and collimates lights emitted from the light source 620, can also be included.

The light source 620 generates a laser beam, which is later reflected and diffracted by the optical modulator 630. When the optical modulator 630 has a one-dimensional array, the laser beam, which is emitted from the light source 620, is projected to all of pixels of the array. Here, the light source 620 emits the laser beams simultaneously in a vertical or horizontal direction, and such laser beams form a two-dimensional image with the help of the optical scanning unit 640. The light source 620 can be composed of a laser or laser diode, and the light source control unit 620 controls the light source 620 to turn on/off, whereupon a laser beam with a required frequency is generated.

The light source control unit 610 can control the wavelength of the light emitted from the light source 620. More specifically, the light source control unit 610 controls the light source 620 to emit a calibration beam that is invisible and has a wavelength that can be sensed by the light measuring unit 650 in accordance with an image projected on the screen 660.

The calibration beam passes through the optical modulator 630 and the optical scanning unit 640 to reach the light measuring unit 650. The light measuring unit 650 measures the quantity or the frequency of the calibration beam. Here, the light measuring unit 650 is disposed at a position where the light measuring unit 650 can sense the calibration beam. For example, the light measuring unit 650 can be disposed at a position where it can receive the calibration beam directly from the optical scanning unit 640 or from an additional reflection unit.

The measured quantity of the calibration beam indicates a degree at which a pixel of the optical modulator 630 is degraded, whereupon a voltage applied to each pixel is controlled to perform calibration. The light measuring unit 650 can have an array structure corresponding to the array of the pixels.

Here, the light measuring unit 650 can be a photo diode sensor, a CMOS image sensor, a CCD image sensor, or the like. The photo diode sensor refers to an optical sensor converting optical energy to electrical energy, and is fabricated by adding light detecting function to a PN junction of a semiconductor. The CMOS image sensor is composed of a plurality of unit pixels having a photo diode and is arranged in a one- or two-dimensional array. Here, the unit pixel is driven by a control circuit or signal processing. And, the CCD image sensor is composed a plurality of MOS capacitors, and operates by transmitting electric charges (carriers) to the MOS capacitors. The image sensor as described above is composed of a plurality of pixels that can sense light.

Also, in the case that the light measuring unit 650 senses the frequency of the calibration beam, it can check whether the calibration beam deviates from a reference path, along which the calibration beam is supposed to travel from the optical scanning unit 640 to the light measuring unit 650. That is, the light source 620 emits a calibration beam with a certain period determined by the light source control unit 610, and in the case that the period or the position of a device is altered, the beam deviates from the expected path. Therefore, by measuring a light path error, such an alteration can be modified.

Here, the light measuring unit 650 can detect the frequency of the calibration beam in a variety of methods, and, for example, the light measuring unit 650 can be formed of a material having a work function that allows the material to generate a photon when it receives a beam with a higher frequency than a certain frequency.

Here, the calibration beam can be projected in accordance with an edge of a frame of an image outputted by the optical modulator 630. Since the calibration beam can have different frequency and form from those of a beam forming an image, the calibration beam is projected to the edge of the frame in order to form a frame having a uniform image quality.

An optical scanning unit controller (not shown) controls the optical scanning unit 640 to be turned on/off, and the optical scanning unit 640 rotates at a constant angular speed. Such an optical scanning unit 640 has a polygonal shape, each facet of which reflects an incident beam. The beam reflected from the optical scanning unit 640 is projected on the screen 660, forming an array of spots, which create an image on the screen 660. For example, in the case that the optical scanning unit 640 has a resolution of VGA 640×480, each facet of the optical scanning device 640 modulates 640 times for 480 longitudinal pixels, thereby generating one frame per facet. The optical scanning unit 640 has a bidirectionally rotatable motor (not shown), and rotates due to the motor, reflecting to the screen 660 an incident beam projected through the optical modulator 630. Here, the optical scanning unit 640 can be a polygon mirror, a rotating bar, a Galvano mirror or the like.

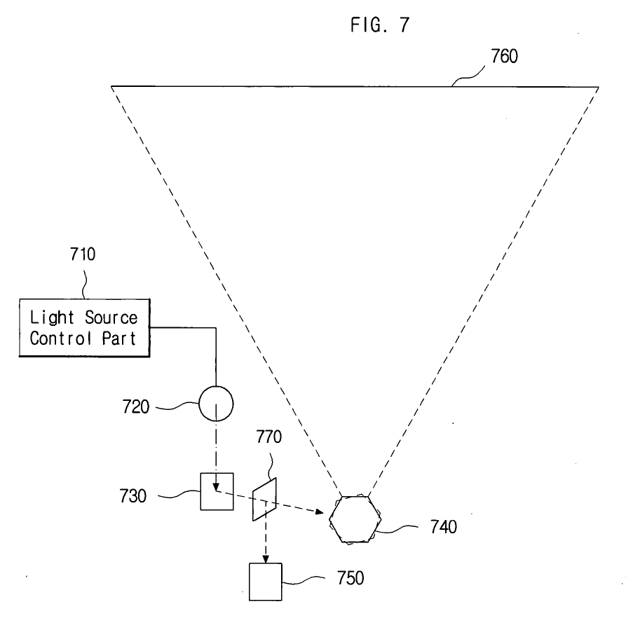

FIG. 7 is a schematic view of a calibration apparatus for an optical modulator according to a second embodiment of the present invention. In FIG. 7 are shown a light source control unit 710, a light source 720, an optical modulator 730, an optical scanning unit 740, a light measuring unit 750, a screen 760, and a semi-transmission filter 770.

The semi-transmission filter 770 is located between the optical modulator 730 and the optical scanning unit 740 in order to reflect a part of light emitted from the optical modulator 730 and transmit the rest of the light.

The light transmitted in one direction through the semi-transmission filter 770 is reflected by the optical scanning unit 740 to be projected on the screen 760, and the light reflected and transmitted in another direction by the semi-transmission filter 770 travels to the light measuring unit 750.

Here, the semi-transmission filter 770 can be implemented in various ways. For example, the semi-transmission filter 770 can be a dielectric mirror having a multi-layered dielectric filter, functioning as an optical resonator, which allows a part of an incident light to pass through and the rest of the incident light to be reflected. Dielectric materials such as TiO2 and SiO2 can be stacked to construct the multi-layered dielectric filter. In order to reflect approximately half of the incident light and transmit the rest of the light, a resonance wavelength should be considered when determining the number of the dielectric layers and the thickness of each dielectric layer.

Here, it should be noted that the present invention can also be embodied such that the light reflected by the semi-transmission filter 770 is projected to the screen 760 via the optical scanning unit 740, and the light transmitted through the semi-transmission filter 770 travels to the light measuring unit 750.

While the invention has been described with reference to the disclosed embodiments, it is to be appreciated that those skilled in the art can change or modify the embodiments without departing from the scope and spirit of the invention or its equivalents as stated below in the claims.

What is claimed is:

1. A calibration apparatus for an optical modulator comprising:
a light source emitting a beam to the optical modulator;
an optical scanning unit scanning and projecting a beam emitted from the optical modulator;
a light measuring unit measuring a beam emitted from the light source; and
a light source control unit controlling the light source to the optical scanning unit to emit a calibration beam that is invisible and can be sensed by the light measuring unit.

2. The apparatus of claim 1, wherein the light measuring unit detects a beam emitted from the light source, and measures the quantity of light of the beam.

3. The apparatus of claim 1, wherein the calibration beam is projected in accordance with an edge of a frame of an image outputted by the optical modulator.

4. The apparatus of claim 1, wherein the light measuring unit is chosen from among a photodiode sensor, a CMOS image sensor, and a CCD image sensor.

5. A calibration apparatus for an optical modulator comprising;
a light source emitting a beam to the optical modulator;
a semi-transmission filter partially transmitting a beam outputted from the optical modulator;
an optical scanning unit scanning and projecting a beam transmitted by the semi-transmission filter in one direction;
a light measuring unit measuring a beam transmitted by the semi-transmission filter in another direction; and
a light source control unit controlling the light source to emit to the optical scanning unit a calibration beam that is invisible and can be sensed by the light measuring instrument.

6. The apparatus of claim 5, wherein the optical scanning unit scans a beam transmitted by the semi-transmission filter, and the light measuring unit measures a beam reflected by the semi-transmission filter.

7. The apparatus of claim 5, wherein the optical scanning unit scans a beam reflected by the semi-transmission filter, and the light measuring unit measures a beam transmitted by the semi-transmission filter.

8. The apparatus of claim 5, wherein the light measuring unit measures the quantity of a beam emitted from the light source.

9. The apparatus of claim 5, wherein the light measuring unit measures the frequency of a beam emitted from the light source.

10. The calibration apparatus of claim 5, wherein the calibration beam is projected in accordance with an edge of a frame of an image outputted by the optical modulator.

11. The calibration apparatus of claim 5, wherein the light measuring unit is chosen from among a photodiode sensor, a CMOS image sensor, and a CCD image sensor.

12. A calibration apparatus for an optical modulator comprising;
a light source emitting a beam to the optical modulator;
an optical scanning unit scanning and projecting a beam outputted from the optical modulator;
a light measuring unit measuring a beam reflected from the optical scanning unit in a predetermined direction; and
a light source control unit controlling the light source to emit to the optical scanning unit a calibration beam that is invisible and can be sensed by the light measuring unit.

13. The apparatus of claim 12, wherein the light measuring unit measures the quantity of a beam emitted from the light source

14. The apparatus of claim 12, wherein the light measuring unit measures the frequency of a beam emitted from the light source.

15. The calibration apparatus of claim 12, wherein the calibration beam is projected in accordance with an edge of a frame of an image outputted by the optical modulator

16. The calibration apparatus of claim 12, wherein the light measuring unit is chosen from among a photodiode sensor, a CMOS image sensor, and a CCD image sensor.
